(19) United States
(12) Patent Application Publication
(10) Pub. No.: US 2010/0299131 A1
(43) Pub. Date: Nov. 25, 2010

(54) TRANSCRIPT ALIGNMENT

(75) Inventors: Drew Lanham, Menlo Park, CA (US); Daryl Kip Watters, Marietta, GA (US); Marsal Gavalda, Sandy Springs, GA (US)

Correspondence Address: OCCHIUTI ROHLICEK & TSAO, LLP, 10 FAWCETT STREET, CAMBRIDGE, MA, 02138, US

(73) Assignee: Nexidia Inc., Atlanta, GA (US)

(21) Appl. No.: 12/469,916

(22) Filed: May 21, 2009

(51) Int. Cl. G10L 15/26; G06F 17/28

(52) U.S. Cl. 704/2; 704/235; 704/E15.043

(57) ABSTRACT

Some general aspects relate to systems, software, and methods for media processing. In one aspect, a script associated with a multimedia recording is accepted, wherein the script includes dialogue, speaker indications and video event indications. A group of search terms are formed from the dialogue, with each search term being associated with a location within the script. Zero or more putative locations of each of the search terms are identified in a time interval of the multimedia recording. For at least some of the search terms, multiple putative locations are identified in the time interval of the multimedia recording. The time interval of the multimedia recording and the script are partially aligned using the determined putative locations of the search terms and one or more of the following: a result of matching audio characteristics of the multimedia recording with the speaker indications, and a result of matching video characteristics of the multimedia recording with the video event indications. Based on a result of the partial alignment, event-localization information is generated. Further processing of the generated event-localization information is enabled.

### CROSS-REFERENCE TO RELATED APPLICATIONS

This application is related to U.S. application Ser. No. 12/351,991, filed Jan. 12, 2009, which is a continuation application of U.S. Pat. No. 7,487,086, issued Feb. 2, 2009, which is a continuation application of U.S. Pat. No. 7,231,351, issued Jun. 12, 2007, which claims the benefit of U.S. Provisional Application Ser. No. 60/379,291, filed May 10, 2002. The above applications are incorporated herein by reference.

### BACKGROUND

This description relates to alignment of multimedia recordings with transcripts of the recordings.

Many current speech recognition systems include tools to form “forced alignment” of transcripts to audio recordings, typically for the purposes of training (estimating parameters for) a speech recognizer. One such tool was a part of the HTK (Hidden Markov Model Toolkit), called the Aligner, which was distributed by Entropic Research Laboratories. The Carnegie-Mellon Sphinx-II speech recognition system is also capable of running in forced alignment mode, as is the freely available Mississippi State speech recognizer.

The systems identified above force-fit the audio data to the transcript. Typically, some amount of manual alignment of the audio to the transcript is required before the automatic alignment process begins. The forced-alignment procedure assumes that the transcript is a perfect and complete transcript of all of the words spoken in the audio recording, and that there are no significant segments of the audio that contain noise instead of speech.

### SUMMARY

Some general aspects relate to systems, methods, and software for media processing. In one aspect, a script associated with a multimedia recording is accepted, wherein the script includes dialogue, speaker indications and video event indications. A group of search terms are formed from the dialogue, with each search term being associated with a location within the script. Zero or more putative locations of each of the search terms are identified in a time interval of the multimedia recording. For at least some of the search terms, multiple putative locations are identified in the time interval of the multimedia recording. The time interval of the multimedia recording and the script are partially aligned using the determined putative locations of the search terms and one or more of the following: a result of matching audio characteristics of the multimedia recording with the speaker indications, and a result of matching video characteristics of the multimedia recording with the video event indications. Based on a result of the partial alignment, event-localization information is generated. Further processing of the generated event-localization information is enabled.

Embodiments of the aspect may include one or more of the following features.

At least some of the dialogue included in the script is produced from the multimedia recording.

A word spotting approach may be applied to determine one or more putative locations for each of the plurality of search terms.

Each of the putative locations may be associated with a score characterizing a quality of match of the search term and the corresponding putative location.

In another aspect, a script associated with a multimedia recording is accepted, wherein the script includes dialogue-based script elements and non-dialogue-based script elements. A group of search terms are formed from the dialogue-based script elements, with each search term being associated with a location within the script. Zero or more putative locations of each of the search terms in a time interval of the multimedia recording, and for at least some of the search terms, multiple putative locations are determined in the time interval of the multimedia recording. A model is generated for mapping at least some of the script elements onto corresponding media elements of the multimedia recording based at least in part on the determined putative locations of the search terms. Base on the model, localization of the multimedia recording is enabled.

Embodiments of this aspect may include one or more of the following features.

At least some of the dialogue-based script elements are produced from the multimedia recording.

A word spotting approach may be applied to determine one or more putative locations for each of the plurality of search terms.

Each of the putative locations with a score characterizing a quality of match of the search term and the corresponding putative location.

In some embodiments, a user-specified text-based search term is received through a user interface. Based on the generated model, one or more occurrences of the user-specified text-based search term are identified within the multimedia recording. The multimedia recording can then be navigated to one of the identified one or more occurrences of the user-specified text-based search term based on a user-specified selection received through the user interface.

In some other embodiments, a user-specified search criteria is received through a user interface, and at least one non-dialogue-based script element in the script is associated with the user-specific search criteria. Based on the generated model, one or more occurrences of the non-dialogue-based element are associated with the search criteria within the multimedia recording, allowing the multimedia recording to be navigated to one of the identified one or more occurrences of the non-dialogue-based script element according to a user-specified selection received through the interface.

The non-dialogue-based script elements may include an element associated with speaker identifier. The non-dialogue-based script elements may also include an element associated with non-dialogue-based characteristics of segments of the multimedia recording. The non-dialogue-based script elements may also include statistics on speaker turns.

A specification of a time-aligned script may be formed including dialogue-based script elements arranged in an order corresponding to a time progression of the multimedia recording.

A specification of a continuity script may be formed including both dialogue-based elements and non-dialogue-based elements arranged in an order corresponding to a time progression of the multimedia recording. Localization of the multimedia recording can be performed based on the non-dialogue-based elements in the continuity script.

In another aspect, a script that is at least partially aligned to a time interval of a multimedia recording is accepted, wherein the script includes a plurality of script segments each associated with a corresponding location in the time interval of the multimedia recording. The script is processed to segment the multimedia recording to form a group of multimedia recording segments, including associating each script segment with a corresponding multimedia recording segment. A visual representation of the script is generated during a presentation of the multimedia recording that includes successive presentations of one or more multimedia recording segments. For each one of the successive presentations of one or more multimedia recording segments, a respective visual representation of the script segment associated with the corresponding multimedia recording segment is generated.

Embodiments of this aspect may include one or more of the following features.

For each one of the successive presentations of one or more multimedia recording segments, a time onset of the visual representation of the script segment is determined relative to a time onset of the presentation of the corresponding multimedia recording segment. Also, for each one of the successive presentations of one or more multimedia recording segments, visual characteristics of the visual representation of the script segment associated with the corresponding multimedia recording segment are determined.

In some embodiments, an input may be accepted from a source of a first identity, and according to the input, the script is processed to associate at least one script segment with a corresponding multimedia recording segment. A second input is accepted from a source of a second identity different from the first identity, and according to the second input, the script is processed to associate at least one script segment with a corresponding multimedia recording segment. The source of the first identity and the source of the second identity may be members of a community.

The text of the visual representation of the script is in a first language, and audio of the presentation of the multimedia recording is in a second language. The first language may be different from, or the same as, the second language.

In another aspect, a script that is at least partially aligned to a time interval of a first multimedia recording is accepted, wherein the script includes a plurality of script segments each associated with a corresponding location in the time interval of the first multimedia recording. A second multimedia recording associated with the multimedia recording is accepted. A group of search terms are formed from the script elements in the script, with each search term being associated with a location within the script. Zero or more putative locations of each of the search terms are in a time interval of the second multimedia recording are determined, and for at least some of the search terms, multiple putative locations in the time interval of the second multimedia recording are determined. A model is generated for mapping at least some of the script elements onto corresponding media elements of the second multimedia recording based at least in part on the determined putative locations of the search terms. At least one media element in the first multimedia recording is associated with a corresponding media element in the second multimedia recording according to the generated model and the partial alignment of the script to the first multimedia recording.

In some embodiments, the media element in the first multimedia may be replaced with the associated media element in the second multimedia recording.

In a further aspect, a first script is accepted from a source of a first identity, wherein the first script is at least partially aligned to a time interval of a multimedia recording. A second script is accepted from a source of a second identity different from the first identity, with the second script being at least partially aligned to the time interval of the multimedia recording. A quality of alignment of the first script to the multimedia recording is compared with a quality of alignment of the second script to the multimedia recording. Based on a result of the comparison, one script is selected from the first and the second script for use in a presentation of the multimedia recording.

In some embodiments, a visual representation of the selected script is generated during the presentation of the multimedia recording.

In a further aspect, a script that is at least partially aligned to a time interval of a multimedia recording is accepted, wherein the script includes a plurality of script segments each associated with a corresponding location in the time interval of the multimedia recording, and the multimedia recording includes a multimedia segment not represented in the script. A sequential order of the plurality of script segments is determined based on their corresponding locations in the time interval of the multimedia recording. A location associated with the multimedia not represented in the script is identified in the sequential order of the plurality of script segments. For each script element, compute an actual time lapse from its immediate preceding script element based on their corresponding locations in the time interval of the multimedia recording, and compare the actual time lapse with an expected time lapse determined according to a voice characteristic.

In some embodiments, the multimedia segment not represented in the script includes a voice segment.

In some embodiments, the expected time lapse is determined based on a speed of utterance.

Other features and advantages of the invention are apparent from the following description, and from the claims.

### DESCRIPTION OF DRAWINGS

FIG. 1 is a diagram of a transcript alignment system.

### DESCRIPTION

### 1 Overview

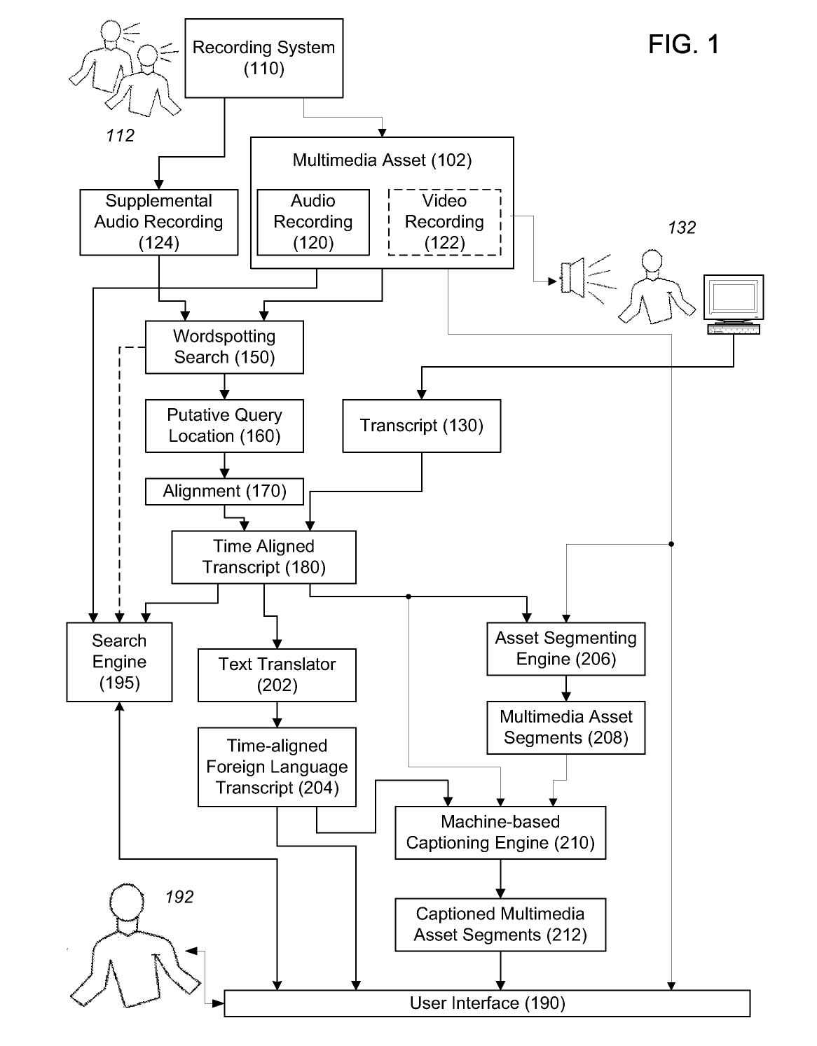

Referring to FIG. 1, a transcript alignment system 100 is used to process a multimedia asset 102 that includes an audio recording 120 (and optionally a video recording 122) of the speech of one or more speakers 112 that have been recorded through a conventional recording system. A transcript 130 of the audio recording 120 is also processed by the system 100. As illustrated in FIG. 1, a transcriptionist 132 has listened to some or all of audio recording 120 and entered a text transcription on a keyboard. Alternatively, transcriptionist 132 has listened to speakers 112 live and entered the text transcription at the time speakers 112 spoke. The transcript 130 is not necessarily complete. That is, there may be portions of the speech that are not transcribed. The transcript 130 may also account for substantial portions of the audio recording 120 that correspond to background noise when the speakers were not speaking. The transcript 130 is not necessarily accurate. For example, words may be misrepresented in the transcript 130. Furthermore, the transcript 130 may have text that does not reflect specific words spoken, such as annotations or headings.

Generally, alignment of the audio recording 120 and the transcript 130 is performed in a number of phases. First, the text of the transcript 130 is processed to form a number of queries 140, each query being formed from a segment of the transcript 130, such as from a single line of the transcript 130. The location in the transcript 130 of the source segment for each query is stored with the queries. A wordspotting-based query search 150 is used to identify putative query location 160 in the audio recording 120. For each query, a number of time locations in audio recording 120 are identified as possible locations where that query term was spoken. Each of the putative query locations is associated with a score that characterizes the quality of the match between the query and the audio recording 120 at that location. An alignment procedure 170 is used to match the queries with particular of the putative locations. This matching procedure is used to form a time-aligned transcript 180. The time-aligned transcript 180 includes an annotation of the start time for each line of the original transcript 130 that is located in the audio recording 120. The time-aligned transcript 180 also includes an annotation of the start time for each non-verbal sound (e.g., background music or silence) that is detected in the audio recording 120. A user 192 then browses the combined audio recording 120 and time-aligned transcript 180 using a user interface 190. One feature of this interface 190 is that the user can use a wordspotting-based search engine 195 to locate search terms. The search engine uses both the text of time-aligned transcript 180 and audio recording 120. For example, if the search term was spoken but not transcribed, or transcribed incorrectly, the search of the audio recording 120 may still locate the desired portion of the recording. User interface 190 provides a time-synchronized display so that the audio recording 120 for a portion of the text transcription can be played to the user 192.

Transcript alignment system 100 makes use of wordspotting technology in the wordspotting query search procedure 150 and in search engine 195. One implementation of a suitable wordspotting based search engine is described in U.S. Pat. No. 7,263,484, filed on Mar. 5, 2001, the contents of which are incorporated herein by reference. The wordspotting based search approach of this system has the capability to:
accept a search term as input and provides a collection of results back with a confidence score and time offset for each
allow a user to specify the number of search results to be returned, which may be unrelated to the number of actual occurrences of the search term in the audio.

The transcript alignment system 100 attempts to align lines of the transcript 130 with a time index into audio recording 120. The overall alignment procedure carried out by the transcript alignment system 100 consists of three main, largely independent phases, executed one after the other: gap alignment, optimized alignment, and blind alignment. The first two phases each align as many of the lines of the transcript to a time index into the media, and the last then uses best-guess, blind estimation to align any lines that could not otherwise be aligned. One implementation of a suitable transcript alignment system that implements these techniques is described in U.S. application Ser. No. 12/351,991, filed Jan. 12, 2009.

It is valuable to have some simple metric by which to judge how well the transcript 130 was aligned to the audio recording 120. This can provide feedback to a recording technician regarding the quality of the audio recording 120 or can be taken to reflect the quality of the transcript 130. Also, this score can be used to estimate the number of alignment errors that are likely to have been made during the alignment process.

Through the gap alignment and optimized alignment phases, specific search results were first tentatively selected and then fixed or definitely selected for many of the lines in the transcript—at which point the time offset of the definitely selected search result was taken to be the time offset at which that line occurred in the media, and the line was marked as “aligned”. The overall alignment score metric is the average score for the definitely selected search results for each spoken line of the transcript. If there is no spoken text on the line to align, it is ignored in the score calculation. Those lines that could not be aligned by selecting a search result, and which were therefore “aligned” through the blind alignment process, are included in the average but contribute a score of zero.

### 2 Applications

### 2.1 Navigation by Located Text

Suppose, for example, that the audio recording 120 contains English language speech and the transcript 130 of the audio recording 120 is an English language transcript. The time-aligned English language transcript 180 that is formed as a result of the alignment procedure 170 may be processed by a text translator 202 to form any number of foreign language transcripts 204, e.g., a transcript containing German language text and a transcript containing French language text. In general, the text translator 202 is operable to draw associations between a word or word sequence in a source language and a word or word sequence in a target language. The text translator 202 can be implemented as a machine-based text translator, a human text translator, or a combination of both. A “basic” machine-based text translator may generate a foreign language transcript that represents a word-for-word translation of the source language transcript with minimal or no regard for the target language's sentence structure. A foreign language transcript generated by a more sophisticated machine-based text translator or human text translator may account for the target language's sentence structure, slang and/or colloquial terms, and phrases. In some examples, in addition to forming the foreign language transcripts 204, the text translator 202 also performs “captioning” and/or “dubbing” operations on the foreign language transcripts 204. Further discussions of these two operations are provided in a later section in this document.

Recall that the time-aligned English language transcript 180 includes an annotation of the start time for each line of the original English language transcript 130 that is located in the audio recording 120. The text translator 202 may be implemented to use the annotations from the time-aligned English language transcript 180 to form a time-aligned foreign language transcript. Each such time-aligned foreign language transcript would generally include an annotation of the start time for each line of the foreign language transcript that corresponds to a line of the original English language transcript 130 that is located in the audio recording 120. Note, as an example, that the time alignment survives the translation process even if the number of words that form an English language transcript line is different (significantly or otherwise) from those that form the corresponding foreign language transcript line. Further note, as an example, that the time alignment survives the translation process even if the order of the words/phrases that form an English language transcript line is different (significantly or otherwise) from those that form the corresponding foreign language transcript line.

The user 192 can browse the combined audio recording 120 and time-aligned foreign language transcript 204 using the interface 190. In one example, when the user 192 enters a text-based search term through the interface 190, a text search engine recognizes that the text-based search term is in German, searches the time-aligned German-language transcript 204 to find occurrences of the search term, and presents the results of the search in a result list. When the user 192 clicks on a result in the result list, a Media Player window of the interface 190 will queue the audio recording 120 to the appropriate location and playback the audio recording 120.

In some examples, the transcript 130 includes both dialogue and non-dialogue based elements (e.g., speaker ID, editorial notes, bookmarks, scene/background changes, and external sources). These non-dialogue elements can also be effectively time aligned to the time-aligned transcript 204 based on their relationship to the dialogue of the time-aligned transcript 180. Further, the synchronization of non-dialogue elements in the transcript to the corresponding non-dialogue elements in the audio/video is useful in searching and navigating the audio and/or video recording. In some other examples, in addition to generating the time-aligned transcript 180, the process of transcript alignment 170 can also create a continuity script that provides not only the complete dialog in the order in which it occurs in the multimedia, but also time-stamped non-dialog based features such as speaker ID, sound effects, scene changes, and actor's accents and emotions. As a result, the user 192 can perform audio/video navigation using additional search mechanisms, for example, by speaker ID, statistics on speaker turns (such as total utterance duration), and scene changes. Sub-clips of audio (and/or video) can be viewed or extracted based on the search results. External sources linked to the search results can also be accessed, for example, by displaying URLs for the external sources in a result panel in the interface 190. Speaker-specific scripts that list all the utterances of particular speaker(s) may be generated.

### 2.2 Captioning

Suppose, for example, that the audio recording 120 contains English language speech and the transcript 130 of the audio recording 120 is an English language transcript. A time-aligned English language transcript 180 may be formed as a result of the alignment procedure 170 as previously described. An asset segmenting engine 206 processes the time-aligned English language transcript to segment the multimedia asset 102 that includes the audio recording 120 such that each line of the time-aligned English language transcript has a corresponding multimedia asset segment 208.

### 2.2.1 Machine-Based Captioning

The multimedia asset segments 208 may be subjected to one or more machine-based captioning processes. In some implementations, a machine-based captioning engine 210 takes the time-aligned English language transcript 180 (and/or the time-aligned foreign language transcript 204) and the multimedia asset segments 208 as input and determines when and where to overlay the text of the time-aligned English language transcript 180 on the video aspects of the multimedia asset segments 208. Recall that the time-aligned English language transcript 180 (and/or the time-aligned foreign language transcript 204) may include an annotation of the start time for each non-verbal sound that is detected in the audio recording 120. In such cases, the machine-based captioning engine 210 may overlay captions indicative of the non-verbal sound (e.g., background music and silence) as an aid for people who are deaf or hard-of-hearing.

In some examples, such machine-based captioning processes are implemented in a highly automatic manner and may use design approaches that are generally insensitive to the needs or interests of specific audience groups. The output of the machine-based captioning engine 210 is a set of captioned multimedia asset segments 212.

### 2.2.2 Community-Based Captioning

The multimedia asset segments may also be subjected to one or more community-based captioning processes. As used in this description, a “community” generally refers to any group of individuals that shares a common interest of captioning multimedia asset segments. A community may be formed by a group of experts, professionals, amateurs or some combination thereof. The members of the community may have established relationships with one another, or may be strangers to one another. Each asset segment (208) can have a score associated with it that an application built to enable community captioning will leverage to indicate the quality of the transcription of a particular segment and signal to the user, the community, and/or the content owner the need to either manually revisit this segment or replace the present transcription with a high scoring transcription provided by another member of the community.

In each type (e.g., same language and native language) of community-based captioning process outlined below, the segments of a multimedia asset are processed by at least two members of a community, and each segment of the multimedia asset is processed by least one member of the community. To generate a captioned presentation of the multimedia asset to viewers, caption files (including transcriptions of the segments of the multimedia asset) that result from the captioning process are further processed by a machine and/or human operator to add the captions to the picture using conventional captioning techniques.

Same language captions, i.e., without translation, are primarily intended as an aid for people who are deaf or hard-of-hearing. Subtitles in the same language as the dialogue are sometimes edited for reading speed and readability. This is especially true if they cover a situation where many people are speaking at the same time, or where speech is unstructured or contains redundancy. An exemplary end result of processing a multimedia asset segment in accordance with community-based same language captioning techniques is a caption file that includes a same language textual version of the dialogue being spoken in the audio segment, non-dialogue identifiers (e.g., “(sighs)”, (“screams”), and “(door creaks”)), and speaker identifiers.

Native language captions typically take the form of subtitles that translate dialogue from a foreign language to the native language of the audience. Very generally, when a film or TV program multimedia asset segment is subtitled, a community member watches the picture and listens to the audio. The community member may or may not have access to the English language transcript (time-aligned or otherwise) that corresponds to the multimedia asset segment 208. Often times, the community member interprets what is meant, rather than providing a direct translation of what was said. In so doing, the community member accounts for language variances due to culturally implied meanings, word confusion, and/or verbal padding. An exemplary end result is a caption file that includes a native language textual interpretation of the dialogue being spoken in the audio segment, non-dialogue identifiers (e.g., “(sighs)”, (“screams”), and “(door creaks”)), and speaker identifiers.

Foreign language captions typically take the form of subtitles that translate dialogue from a native language to the foreign language of a user. This may be desired, for example, to a movie making community that wishes to promote an English-language movie to a non-English speaking population. In some examples, one or more members of the community may act as a transcriptionist to create a transcript (or portions of a transcript) of a multimedia asset that was produced in the member's native language, say, English. A time-aligned English transcript may then be formed as a result of the alignment procedure 170 as previously described. This time-aligned English transcript can be processed, for example, by the text translator 202 to form a foreign language transcript, based on which further applications such as captioning and dubbing can be performed.

Community-based captioning of multimedia assets leverages the reach of the Internet by enabling any number of community members to participate in the captioning process. This has the positive effect of speeding up the rate at which libraries of multimedia assets are captioned.

### 2.3 Dubbing

The term “dubbing” generally refers to the process of recording or replacing voices for a multimedia asset 102 that includes an audio recording 120. Multimedia assets 102 are often dubbed into the native language of the target market to increase the popularity with the local audience by making the asset more accessible. The voices being recorded may belong to the original actors (e.g., an actor re-records lines they spoke during filming that need to be replaced to improve audio quality or reflect dialogue changes) or belong to other individuals (e.g., a voice artist records lines in a foreign language).

Suppose, for example, it is desired that certain lines that were recorded during filming be replaced. Recall that a speaker-specific script that lists all the utterances of a particular speaker may be generated by the system 100. An actor or voice artist may re-record any number of lines from a particular speaker-specific script. Each line that is re-recorded forms a supplemental audio recording 122. Recall that the text of a transcript associated with a multimedia asset may be processed to form a number of queries, each query being formed from a segment of the transcript, such as from a single line of the transcript. A wordspotting based query search may be performed to determine whether any query term was spoken in the supplemental audio recording 122, and a score may be generated to characterize the quality of the match between the query term and the supplemental audio recording 122. Using conventional post-production techniques, a modified audio recording may be generated by splicing the supplemental audio recording 122 into the original audio recording 102. A modified time-aligned transcript that includes an annotation of the start time for each line of the original transcript that is located in the modified audio recording may be formed using the previously-described alignment procedure.

In the alternative, suppose it is desired that an English language audio track for the multimedia asset be replaced with a German language audio track. The voice artists first watch the picture and listen to the audio to get a feel of the tone of the original speech. The voice artists then record their lines. Very generally, the lines that are recorded by any one given voice artist form a supplemental audio recording. In some examples, the resulting set of supplemental audio recordings are processed to determine which query terms were spoken in each of the supplemental audio recordings, and scores that characterize the quality of the respective matches are also generated. In some other examples, a time-aligned map for dialogue-based events is generated to enable localized versions (captioning or dubbing) to be reinserted at the appropriate place within the audio or video production. Using conventional post-production techniques, a German language audio recording may be generated by splicing together the segments of the various supplemental audio recordings. A modified time-aligned transcript that includes an annotation of the start time for each line of the English language transcript that is located by proxy in the modified audio recording may be formed using the previously-described alignment procedure. In some other examples, to produce the German language audio recording, a time-aligned mapping of the English transcript and the English audio recordings is first generated, for example, using the previously-described alignment procedure. Similarly, a time aligned mapping of the German transcript and the supplemental audio segments recorded by voice artists can also be generated. These text-audio mappings, which can include both dialogue based and non-dialogue based elements (e.g., voice artist ID, audio segment ID), together with an English-German text-text mapping, may be used as the basis for producing a German language audio recording that can replace the English audio recording.

The process described in the above two paragraphs may be highly automated and has the positive effect of reducing the amount of time that is spent on post-production even if multiple lines of the multimedia asset need to be replaced.

### 2.4 Multimedia Asset Manipulation

Suppose, for example, that the multimedia asset includes an audio recording containing English language speech and the transcript of the audio recording is an English language transcript. A time-aligned English language transcript can be formed using the previously-described alignment procedure. The user 192 can browse the combined multimedia asset and time-aligned transcript using the interface 190 and manipulate the multimedia asset in any one of a number of ways.

In one example, when the user 192 highlights one or more lines of the time-aligned transcript, the system 100 automatically selects the segment of the multimedia asset corresponding to the highlighted text and enables the user 192 to manipulate the selected segment within the interface 190 (e.g., playback of the selected segment of multimedia asset). The system 100 may also be operable to generate a copy of the selected segment of the multimedia asset and package it in a manner that enables the user 192 to replay the selected segment through a third-party system (e.g., a web page that includes a link to a copy of the selected segment stored within the system 100 or outside of the system 100).

In another example, the system 100 is operable to enable the user 192 to move text of the time-aligned transcript around to re-sequence the segments of the multimedia asset. Both the re-arranged text and re-sequenced segments may be stored separately or in association with one another within (or outside) the system 100.

### 2.5 Other Applications

The above-described systems and techniques can be useful in a variety of speech or language-related applications. Multimedia captioning and dubbing are two examples. Another example relates to media processing including the chapterization of video based on external metadata or associated text source (e.g., iNews rundowns based on editorial notes, and the segmentation of classroom lecture recording based on the corresponding PowerPower presentation). Other examples include indentifying story segment boundaries, and extracting entities of the captioning to automate tagging, some of which can be performed based on the script, the metadata, or a combination thereof.

In some other applications, there are times when transcripts have spoken content omitted, for example, due to improvisation and untracked edits in post production. In some embodiments of the transcript alignment system 100, the time-aligned transcript 180 does not necessarily identify explicitly portions of the audio that are not included in the transcript as lines immediately preceding and following the missing text will be aligned as consecutive lines in the transcript. One way to identify the missing gaps in the transcript compares the timestamps for all sequential lines in the transcript and identifies gaps in the timestamps that are considered longer than their expected length, for example, as estimated according to an assumed rate of speech in the content. Based on the identified gaps, the system can then flag areas where portions of the transcript are likely missing or deficient. In some examples, the accuracy of identifying audio with missing text can be further improved by implementing a subsequent confirmation step to ensure that the flagged areas in fact correspond to voice activities in the audio, instead of silence or music.

In alternative versions of the system, other audio search techniques can be used. These can be based on word and phrase spotting techniques, or other speech recognition approaches.

In alternative versions of the system, rather than working at a granularity of lines of the text transcript, the system could work with smaller or larger segments such as words, phrases, sentences, paragraphs pages.

Other speech processing techniques can be used to locate events indicated in transcript 130. For example, speaker changes may be indicated in transcript 130 and these changes are then located in audio recording 120 and used in the alignment of the transcript and the audio recording.

The approach can use other or multiple search engines to detect events in the recording. For example, both a word spotter and a speaker change detector can be used individually or in combination in the same system.

The approach is not limited to detecting events in an audio recording. In the case of aligning a transcript or script with a audio-video recording, video events may be indicated in the transcript and located in the video portion of the recording. For example, a script may indicate where scene changes occur and a detector of video scene changes detects the time locations of the scene changes in the video.

The approach described above is not limited to audio recordings. For example, multimedia recordings that include an audio track can be processed in the same manner, and the multimedia recording presented to the user. For example, the transcript may include closed captioning for television programming and the audio recording may be part of a recorded television program. The user interface would then present the television program with the closed captioning.

Transcript 130 is not necessarily produced by a human transcriptionist. For example, a speech recognition system may be used to create an transcript, which will in general have errors. The system can also receive a combination of a recording and transcript, for example, in the form of a television program this includes closed captioning text.

The transcript is not necessarily formed of full words. For example, certain words may be typed phonetically, or typed “as they sound.” The transcript can include a stenographic transcription. The alignment procedure can optionally work directly on the stenographic transcript and does not necessarily involve first converting the stenographic transcription to a text transcript.

Alternative alignment procedures can be used instead of or in addition to the recursive approach described above. For example, a dynamic programming approach could be used to select from the possible locations of the search terms. Also, an in which search terms and a filler model are combined in a grammar can be used to identify possible locations of the search terms using either a word spotting or a forced recognition approach.

The system can be implemented in software that is executed on a computer system. Different of the phases may be performed on different computers or at different times. The software can be stored on a computer-readable medium, such as a CD, or transmitted over a computer network, such as over a local area network.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the techniques described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer (e.g., interact with a user interface element, for example, by clicking a button on such a pointing device). Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The techniques described herein can be implemented in a distributed computing system that includes a back-end component, e.g., as a data server, and/or a middleware component, e.g., an application server, and/or a front-end component, e.g., a client computer having a graphical user interface and/or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet, and include both wired and wireless networks.

The computing system can include clients and servers. A client and server are generally remote from each other and typically interact over a communication network. The relationship of client and server arises by virtue of computer programs running on the respective computers and having a client-server relationship to each other.

It is to be understood that the foregoing description is intended to illustrate and not to limit the scope of the invention, which is defined by the scope of the appended claims. Other embodiments are within the scope of the following claims.

What is claimed is:

1. One or more processor readable storage devices having code embodied on said storage devices, said code for programming one or more processors to perform a method comprising:
accepting a script associated with a multimedia recording, wherein the script includes dialogue, speaker indications and video event indications;
forming a plurality of search terms from the dialogue, each search term associated with a location within the script;
determining zero or more putative locations of each of the search terms in a time interval of the multimedia recording, including for at least some of the search terms, determining multiple putative locations in the time interval of the multimedia recording;
partially aligning the time interval of the multimedia recording and the script using the determined putative locations of the search terms and one or more of the following: a result of matching audio characteristics of the multimedia recording with the speaker indications, and a result of matching video characteristics of the multimedia recording with the video event indications;
using a result of the partial alignment to generate event-localization information; and
enabling further processing of the generated event-localization information.

2. The storage device of claim 1, wherein at least some of the dialogue included in the script is produced from the multimedia recording.

3. The storage device of claim 1 having code embodied thereon for applying a word spotting approach to determine one or more putative locations for each of the plurality of search terms.

4. The storage device of claim 19 having code embodied thereon for associating each of the putative locations with a score characterizing a quality of match of the search term and the corresponding putative location.

5. One or more processor readable storage devices having code embodied on said storage devices, said code for programming one or more processors to perform a method comprising:
accepting a script associated with a multimedia recording, wherein the script includes dialogue-based script elements and non-dialogue-based script elements;
forming a plurality of search terms from the dialogue-based script elements, each search term associated with a location within the script;
determining zero or more putative locations of each of the search terms in a time interval of the multimedia recording, including for at least some of the search terms, determining multiple putative locations in the time interval of the multimedia recording;
generating a model that maps at least some of the script elements onto corresponding media elements of the multimedia recording based at least in part on the determined putative locations of the search terms; and
enabling localization of the multimedia recording using the generated model.

6. The storage device of claim 5, wherein at least some of the dialogue-based script elements are produced from the multimedia recording.

7. The storage device of claim 5 having code embodied thereon for applying a word spotting approach to determine one or more putative locations for each of the plurality of search terms.

8. The storage device of claim 5 having code embodied thereon for associating each of the putative locations with a score characterizing a quality of match of the search term and the corresponding putative location.

9. The storage device of claim 5 having code embodied thereon for enabling localization of the multimedia recording comprising:
receiving a user-specified text-based search term through a user interface;
using the generated model to identify one or more occurrences of the user-specified text-based search term within the multimedia recording; and
enabling navigation of the multimedia recording to one of the identified one or more occurrences of the user-specified text-based search term responsive to a user-specified selection received through the user interface.

10. The storage device of claim 5 having code embodied thereon for enabling localization of the multimedia recording comprising:
receiving a user-specified search criteria through a user interface;
associating at least one non-dialogue-based script element in the script with the user-specific search criteria;
using the generated model to identify one or more occurrences of the non-dialogue-based element associated with the search criteria within the multimedia recording;
enabling navigation of the multimedia recording to one of the identified one or more occurrences of the non-dialogue-based script element responsive to a user-specified selection received through the interface.

11. The storage device of claim 5, wherein the non-dialogue-based script elements include an element associated with speaker identifier.

12. The storage device of claim 5, wherein the non-dialogue-based script elements include an element associated with non-dialogue-based characteristics of segments of the multimedia recording.

13. The storage device of claim 5, wherein the non-dialogue-based script elements include an element associated with statistics on speaker turns.

14. The storage device of claim 5 having code embodied thereon for forming a specification of a time-aligned script having dialogue-based script elements arranged in an order corresponding to a time progression of the multimedia recording.

15. The storage device of claim 5 having code embodied thereon for forming a specification of a continuity script having both dialogue-based elements and non-dialogue-based elements arranged in an order corresponding to a time progression of the multimedia recording.

16. The storage device of claim 15 further having code embodied thereon for enabling the localization of the multimedia recording based on the non-dialogue-based elements in the continuity script.

17. One or more processor readable storage devices having code embodied on said storage devices, said code for programming one or more processors to perform a method comprising:
accepting a script that is at least partially aligned to a time interval of a multimedia recording, wherein the script includes a plurality of script segments each associated with a corresponding location in the time interval of the multimedia recording;
processing the script to segment the multimedia recording to form a plurality of multimedia recording segments, including associating each script segment with a corresponding multimedia recording segment; and
forming a visual representation of the script during a presentation of the multimedia recording that includes successive presentations of one or more multimedia recording segments, including, for each one of the successive presentations of one or more multimedia recording segments, forming a respective visual representation of the script segment associated with the corresponding multimedia recording segment.

18. The storage device of claim 17 having code embodied thereon for forming a visual representation of the script comprising:
for each one of the successive presentations of one or more multimedia recording segments, determining a time onset of the visual representation of the script segment relative to a time onset of the presentation of the corresponding multimedia recording segment.

19. The storage device of claim 17 having code embodied thereon for forming a visual representation of the script comprising:
for each one of the successive presentations of one or more multimedia recording segments, determining visual characteristics of the visual representation of the script segment associated with the corresponding multimedia recording segment.

20. The storage device of claim 17 having code embodied thereon for processing the script to segment the multimedia recording comprising:
accepting an input from a source of a first identity; and
according to the input, processing the script to associate at least one script segment with a corresponding multimedia recording segment.

21. The storage device of claim 20 having code embodied thereon for processing the script to segment the multimedia recording comprising:
accepting a second input from a source of a second identity different from the first identity; and
according to the second input, processing the script to associate at least one script segment with a corresponding multimedia recording segment.

22. The storage device of claim 21, wherein the source of the first identity and the source of the second identity are members of a community.

23. The storage device of claim 17, wherein text of the visual representation of the script is in a first language, and audio of the presentation of the multimedia recording is in a second language.

24. The storage device of claim 23, wherein the first language is the same as the second language.

25. The storage device of claim 23, wherein the first language is different from the second language.

26. One or more processor readable storage devices having code embodied on said storage devices, said code for programming one or more processors to perform a method comprising:
accepting a script that is at least partially aligned to a time interval of a first multimedia recording, wherein the script includes a plurality of script segments each associated with a corresponding location in the time interval of the first multimedia recording;
accepting a second multimedia recording associated with the multimedia recording;
forming a plurality of search terms from the script elements in the script, each search term associated with a location within the script;
determining zero or more putative locations of each of the search terms in a time interval of the second multimedia recording, including for at least some of the search terms, determining multiple putative locations in the time interval of the second multimedia recording;
generating a model that maps at least some of the script elements onto corresponding media elements of the second multimedia recording based at least in part on the determined putative locations of the search terms;
associating at least one media element in the first multimedia recording with a corresponding media element in the second multimedia recording according to the generated model and the partial alignment of the script to the first multimedia recording.

27. The storage device of claim 26 having code embodied thereon for replacing said media element in the first multimedia with the associated media element in the second multimedia recording.

28. One or more processor readable storage devices having code embodied on said storage devices, said code for programming one or more processors to perform a method comprising:
accepting, from a source of a first identity, a first script that is at least partially aligned to a time interval of a multimedia recording;
accepting, from a source of a second identity different from the first identity, a second script that is at least partially aligned to the time interval of the multimedia recording;
comparing a quality of alignment of the first script to the multimedia recording with a quality of alignment of the second script to the multimedia recording; and
based on a result of the comparison, selecting one script from the first and the second script for use in a presentation of the multimedia recording.

29. The storage device of claim 28 having code embodied thereon for:
forming a visual representation of the selected script during the presentation of the multimedia recording.

30. One or more processor readable storage devices having code embodied on said storage devices, said code for programming one or more processors to perform a method comprising:
accepting a script that is at least partially aligned to a time interval of a multimedia recording, wherein the script includes a plurality of script segments each associated with a corresponding location in the time interval of the multimedia recording, and the multimedia recording includes a multimedia segment not represented in the script;
determining a sequential order of the plurality of script segments based on their corresponding locations in the time interval of the multimedia recording; and
identifying, in the sequential order of the plurality of script segments, a location associated with the multimedia not represented in the script, including, for each script element:
computing an actual time lapse from its immediate preceding script element based on their corresponding locations in the time interval of the multimedia recording; and
comparing the actual time lapse with an expected time lapse determined according to a voice characteristic.

31. The storage device of claim 30 wherein the multimedia segment not represented in the script includes a voice segment.

32. The storage device of claim 30 wherein the expected time lapse is determined based on a speed of utterance.
